(19) United States
(12) Patent Application Publication
(10) Pub. No.: US 2006/0281058 A1
(43) Pub. Date: Dec. 14, 2006

(54) A Configurable Multi-Lingual Presentation of an Ancient Manuscript

(75) Inventor: Nola Mangoaela, Long Beach, CA (US)

Correspondence Address: OBI I. ILOPUTAIFE, 2563 N. Falconer Way, Orange, CA, 92867, US

(73) Assignee: Nola Mangoaela, Long Beach, CA (US)

(21) Appl. No.: 11/160,179

(22) Filed: Jun. 13, 2005

(51) Int. Cl. G09B 19/06

(52) U.S. Cl. 434/157

(57) ABSTRACT

A configurable multi-lingual presentation of an ancient manuscript is presented. An ancient manuscript, such as a bible, is configured and presented simultaneously in a plurality of languages, side by side. For instance, an English language translation may be presented in one column of a display while a Spanish language translation is presented in a second column. The presentation may be in electronic media, in which case it could be over a PDA (personal data assistant), a personal computer (e.g. a laptop), an electronic book, a projection in a church or other environment, etc. The presentation may also be printed in book form after final configuration. For instance, a customized book may be generated from preferences specified by a user, leaflets of specific paragraphs may be generated for a specific event, or a regularly bound book may be generated for mass distribution.

### FIELD OF THE INVENTION

This invention relates to the simultaneous visual presentation of ancient manuscripts in a multi-lingual format.

### BACKGROUND OF THE INVENTION

Ancient manuscripts such as the Bible, the Koran, etc. are generally presented in book form and in one language (spoken language). The Holy Bible for instance, which is a collection of several books or writings from different authors, is generally presented in a two column format and in the same language. FIG. 1 is an illustration of a typical presentation format used in most prior art printings of the Holy Bible.

As illustrated, a page of the Holy Bible 100 comprises columns 101 and 102; page index 110; page number 103; chapter indicator 120; verse indicators 121-130. Each verse comprises text 150 representing the text of the particular translation of the Bible. The translation could be in English, Latin, Spanish, or any other language. The translation also may depend on style of the particular translator. For instance, there are several translations of the Bible to the English language, e.g., King James Version, which may have a slightly different translation from the “New American Bible”.

Page index 110 may comprise the book, the chapter, and the verse representing the top line of the page. For instance, in the illustration of FIG. 1, the chapter index indicates that the first line of the page belongs to the book of “1 KINGS” (i.e. First Book of Kings), chapter “17”, and verse “23”. Thus, chapter indicator 120 should read “17”, verse indicator 121 should read “23”, and verse indicator 122 should read “24”, and so on.

Also, some versions of the Holy Bible comprise column 140 which contains cross references to other related paragraphs in the Bible.

However, this configuration (FIG. 1) of the Bible may be inadequate for the present day world. For instance, the present day world is more integrated than before thus communication is becoming more crucial in a world with multiple spoken languages. This level of integration is primarily due to the ease of transportation and communication. For example, there are Ministers from one part of the world who frequently travel to other parts of the world to preach and spread the word of God. The travel can be either in person or by celestial communication (e.g. via satellite). In most instances, the country or region of the ministry speaks a completely different language than the tongue of the visiting Minister.

This language difference may result in difficulties in: sharing resources (e.g. the same Bible); following linearly with the teachings in the bible; preparing common ministry agenda; etc. Thus, it would be most convenient to have a Bible with both the language of the visiting Minister and that of the natives. This is also most advantageous in those countries and regions where the population is multi-lingual.

### SUMMARY OF THE INVENTION

A configurable multi-lingual presentation of an ancient manuscript is presented. Embodiments of the present invention comprise the simultaneous presentation of an ancient manuscript, such as the Bible, in a plurality of languages, side by side. For instance, an English language translation may be presented in one column of a display while a Spanish language translation is presented in a second column of the same display. Thus, easing the burden of cross-referencing and providing multiple versions of the same document for the same ministry.

Embodiments of the presentation may be in electronic media, in which case it could be over a PDA (personal data assistant), a personal computer (e.g. a laptop), an electronic book, a projection in a church or other environment, etc.

Other embodiments of the present invention may be provided in book form after final configuration. For instance, a customized book may be generated from preferences specified by a user, leaflets of specific paragraphs may be generated for a specific church service, or a regularly bound book may be generated for mass distribution using embodiments of the present invention.

### DESCRIPTION OF THE DRAWINGS

FIG. 1 is an illustration of a typical presentation format used in most printings of the Holy Bible.

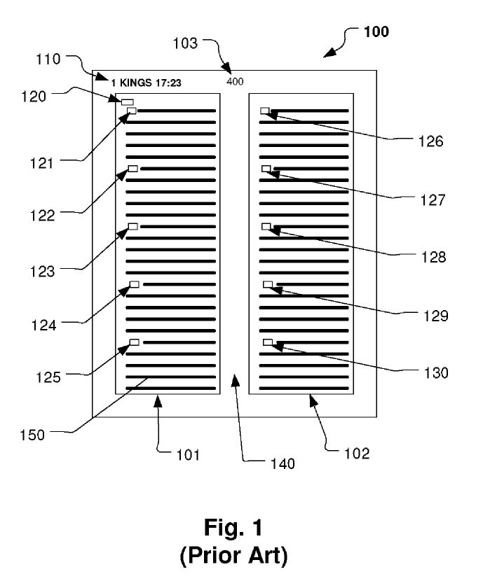

FIG. 2 is an illustration of the presentation of an ancient manuscript in accordance with an embodiment of the present invention.

FIG. 3 is an illustration of a configuration page in accordance with an embodiment of the present invention.

FIG. 4 is a flowchart illustrating the process underlying configuration page 300, in accordance with an embodiment of the present invention.

FIG. 5 is an illustration of an electronic media presentation of an ancient manuscript in accordance with an embodiment of the present invention.

### DETAILED DESCRIPTION OF THE INVENTION

The invention comprises a configurable multi-lingual presentation of an ancient manuscript, and methods thereof. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the present invention comprise the simultaneous presentation of an ancient manuscript, such as the Bible, in a plurality of languages. The presentation may be in electronic media, in which case it could be over a PDA (personal data assistant), a personal computer (e.g. a laptop), an electronic book, a projection in a church or other environment, etc.

The presentations may also be in book form. For instance, a customized book may be generated from preferences specified by a user, leaflets of specific paragraphs may be generated for a specific service, or a regularly bound book may be generated for mass distribution using embodiments of the present invention.

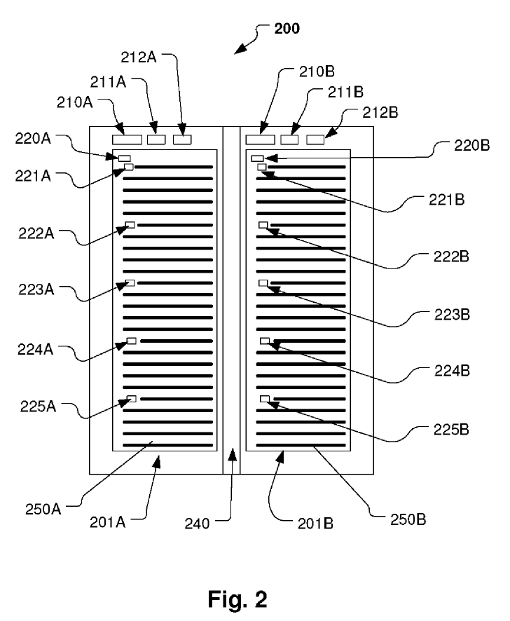

FIG. 2 is an illustration of the presentation of an ancient manuscript in accordance with an embodiment of the present invention. As illustrated, object 200 is a graphical user interface and display of an ancient manuscript in two languages comprising columns 201A and 201B, wherein a first language is displayed in column 201A and a second language of the same text is displayed in column 201B. Both columns 201A and 201B comprise identical information except in different languages.

For instance, column 201A comprises page index objects 210A, 211A, and 212A. The page index indicates the book or author (i.e. 210A), chapter (i.e. 211A), and verse (i.e. 212A) of the top line in the page. Column object 210A may be a graphical display of the book (e.g. “1 Kings”), object 211A may be a graphical indicator of the chapter (e.g. “17”), and object 212A may be an indicator of the verse (e.g. “23”). In one or more embodiments, the book object 210A, chapter object 211A, and verse object 212A are dropdown menus that provide for ease of selection. For instance, in an electronic embodiment, one may select the appropriate verse in the Bible by clicking on the book object 210A thus revealing all the books in the Bible to facilitate selection of the desired book (e.g. “Genesis”) by clicking, for example. Once the desired book is selected, chapter object 211A automatically reconfigures to only contain the chapters in the selected book. The selection of the desired chapter may be accomplished by clicking on the chapter object to reveal a dropdown menu of all the available chapters in the book of “Genesis”. Again, the chapter may be selected by clicking on the desired list item in the dropdown menu.

Finally, once the chapter is selected, verse object 212A automatically reconfigures to only contain the verses in the selected chapter (which is indicated in object 211A). The appropriate verse may thus be selected by clicking and revealing a dropdown menu of the available verses and thus making a selection therefrom.

Column object 201A further comprises chapter indicator 220A and verse indicators 221A, 222A, 223A, 224A, and 225A. Of course, the number of verses contained in one column object 201A will depend on the footprint of the column object and the textual preferences (e.g. font, text size, line spacing, etc.) chosen for the display.

Column object 201B contains similar objects and identical information as column object 201A with the exception that the information may be presented in a second language. Thus, the selection of a desired paragraph may be accomplished using page index 210B, 211B, and 212B, similar to the process discussed for column object 201A.

For instance, column 201B comprises page index objects 210B, 211B, and 212B. The page index indicates the book (i.e. 210B), chapter (i.e. 211B), and verse (i.e. 212B) corresponding to the top line in the page. Column object 210B may be a graphical display of the book (e.g. “1 Kings”), object 211B may be a graphical indicator of the chapter (e.g. “17”), and object 212B may be an indicator of the verse (e.g. “23”).

In one or more embodiments, the book object 210B, chapter object 211B, and verse object 212B are dropdown menus that provide for ease of selection. For instance, in an electronic embodiment, one may select the appropriate verse in the document by clicking on the book object 210B thus revealing all the available books in the document to facilitate selection of the desired book (e.g. “Genesis”). Once the desired book is selected, chapter object 211B automatically reconfigures to only contain the chapters in the selected book. The selection of the desired chapter may be accomplished by clicking on the chapter object 211B to reveal a dropdown menu of all the available chapters in the selected book, e.g., “Genesis”. Again, the chapter may be selected by clicking on the desired list item from the dropdown menu.

Finally, once the chapter is selected, verse object 212B automatically reconfigures to only contain the verses in the selected chapter (which is indicated in object 211B). The appropriate verse may thus be selected by clicking and revealing a dropdown menu of the available verses for making a selection therefrom.

Column object 201B further comprises chapter indicator 220B and verse indicators 221B, 222B, 223B, 224B, and 225B. Of course, the number of verses contained in column object 201B is identical to the number of verses contained in column object 201A. In one or more embodiments, column objects 201A and 201B may be symmetric. In addition, presentation object 200 may include section 240 for display of cross-reference or other pertinent information.

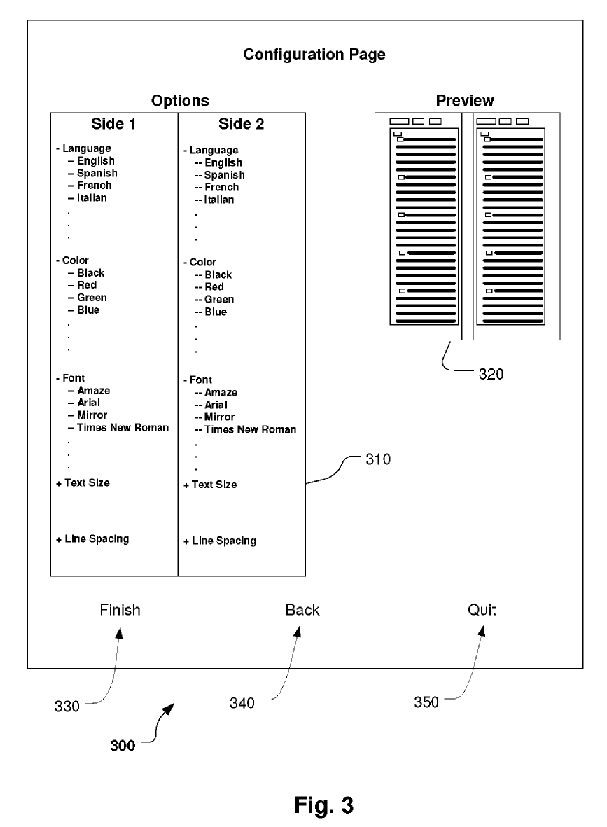

FIG. 3 is an illustration of a configuration page in accordance with an embodiment of the present invention. As illustrated, configuration page 300 comprises Options object 310 and a preview object 320. Options object 310 provides a graphical user interface for interactively configuring the presentation, in accordance with an embodiment of the present invention. For instance, Options object 310 may be divided into Side 1 and Side 2, as illustrated. Options object 310 comprises objects for selecting the desired language, color, font, test size, line spacing, and other preferences of the display for each column of the manuscript. Preview object 320 may reconfigure to reflect the appearance of the display every time a new selection is made from the options menu 310.

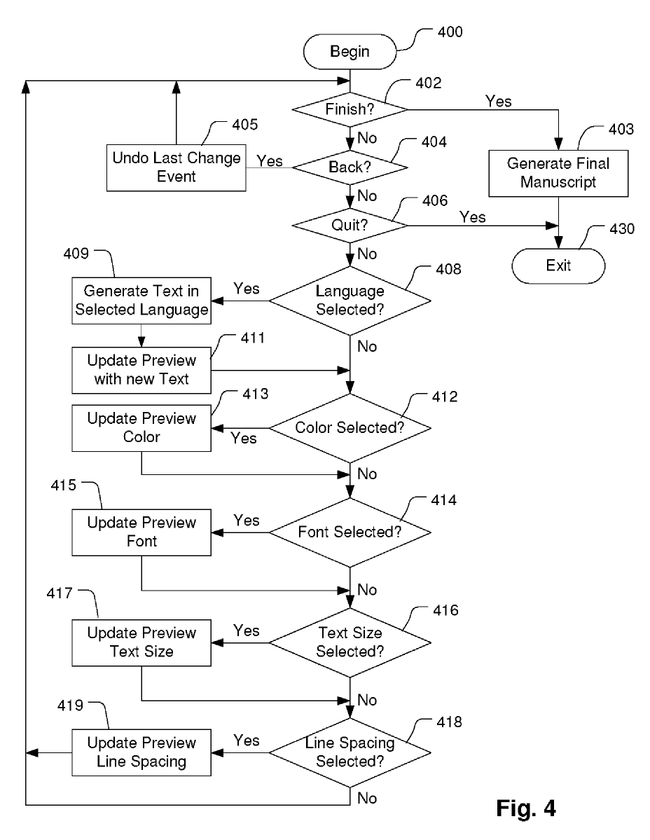

Configuration page 300 further comprises Finish button 330, Back button 340, and Quit button 350. Finish button 330 is used to indicate acceptance of the configuration of the presentation as displayed in the preview object 320. Thus the actual display of the configured manuscript could now be generated and presented. The Back button 340 may be used to undo a selection thus returning to a previous configuration, and the Quit button 350 may be used to exit entirely from the manuscript presentation. The processing and operation is further illustrated in the flowchart of FIG. 4.

FIG. 4 is a flowchart illustrating the process underlying configuration page 300, in accordance with an embodiment of the present invention. As illustrated, the configuration page is entered at 400. At 402, a determination is made whether the Finish button 330 was selected, if so, processing proceeds to process 403 where the final manuscript is generated in the desired presentation media using the configuration displayed in the preview page 320. The process then exits at 430.

However, if the finish button was not selected, processing proceeds to block 404 where a determination is made whether the Back button 340 was selected. If so, processing proceeds to process 405 where the last change event is undone before processing returns to block 402.

However, if the Back button 340 was not selected, processing proceeds to block 406 where a determination is made whether the Quit button 350 was selected. If so, the process exits the configuration page and the presentation at 430. However, if the Quit button is not selected, processing proceeds to block 408. At block 408, a determination is made whether a language selection was made for a particular column. If a language selection was made, processing proceeds to block 409 where a language engine generates the text of the manuscript in the selected language, and the preview page 320 is updated with the text in the new language in block 411. Processing then proceeds to block 412. Also, processing may proceed directly to block 412 if no language selection was made at 408.

At block 412, a determination is made whether a color selection was made. If so, the preview page color is updated at block 413 before proceeding to block 414. If not, processing proceeds to block 414.

At block 414, a determination is made whether a font selection was made. If so, the preview page font is updated at block 415 before proceeding to block 416. If not, processing proceeds to block 416.

At block 416, a determination is made whether a text size selection was made. If so, the preview page text size is updated at block 417 before proceeding to block 418. If not, processing proceeds to block 418.

At block 418, a determination is made whether a line spacing selection was made. If so, the preview page line spacing is updated at block 419 before returning to block 402. If not, processing returns to block 402 to begin the next processing circle.

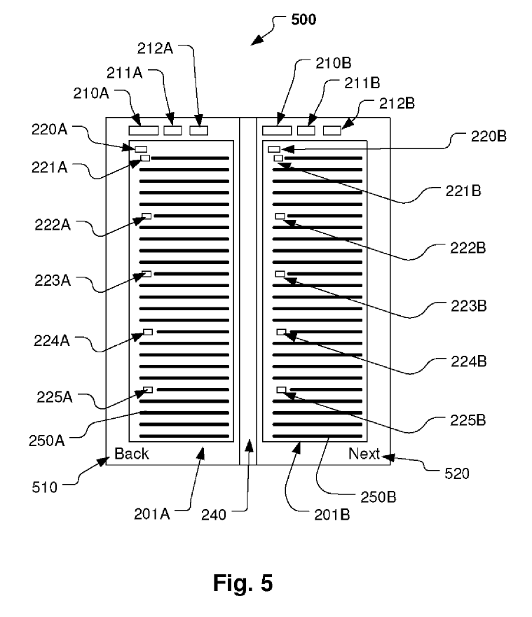

After processing of the configuration page, an electronic embodiment of the configured manuscript may be presented as illustrated in FIG. 5. As illustrated, the display object 500 includes Back (or Previous) button 510 and Next button 520. Back button 510 may be used to flip to the previous page of the configured manuscript. While the Next button 520 may be used to flip to the next (subsequent) page of the configured manuscript.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A presentation of an ancient manuscript comprising:
a display page having a first column and a second column;
a translation of an ancient manuscript in a first language on said first column of said display page; and
a translation of said ancient manuscript in a second language on said second column of said display page, wherein said first language and said second language are not the same.

2. The presentation of claim 1, further comprising:
a page index display.

3. The presentation of claim 2, wherein said page index display comprises:
a book indication;
a chapter indication; and
a verse indication.

4. The presentation of claim 3, wherein said page index provides interactive selection of a desired paragraph of said ancient manuscript.

5. The presentation of claim 4, wherein said display page is an electronic media.

6. The presentation of claim 5, further comprising:
an object for selection of a previous page of said display page; and
an object for selection of a next page of said display page.

7. The presentation of claim 1, wherein said display page is electronic media.

8. The presentation of claim 1, wherein said display page is paper media.

9. The presentation of claim 1, wherein said ancient manuscript is the Bible.

10. The presentation of claim 1, wherein said ancient manuscript is the Koran.

11. A presentation of an ancient manuscript comprising:
a plurality of columns on a display page;
each of said plurality of columns having textual information displayed in a language that is different from other columns on said display page, wherein said textual information consists essentially of a translation of an ancient manuscript in said language.

12. The presentation of claim 11, further comprising:
a page index display for each of said plurality of columns.

13. The presentation of claim 12, wherein said page index display comprises:
a book indication;
a chapter indication; and
a verse indication.

14. The presentation of claim 13, wherein said page index provides interactive selection of a desired paragraph of said ancient manuscript.

15. The presentation of claim 11, wherein said display page is electronic media.

16. The presentation of claim 15, further comprising:
an object for selection of a previous page of said display page; and
an object for selection of a next page of said display page.

17. The presentation of claim 11, wherein said display page is paper media.

18. The presentation of claim 11, wherein said ancient manuscript is the Bible.

19. The presentation of claim 11, wherein said ancient manuscript is the Koran.

20. A method for presentation of a manuscript comprising:
obtaining a manuscript, said manuscript having textual content arranged in a plurality of paragraphs;
providing a first column on a display page, said first column having said textual content of said manuscript in a first language;
providing a second column on a display page, said second column having said textual content of said manuscript in a second language;
arranging said plurality of paragraphs such that each of said paragraph begins on a corresponding line on both said first column and said second column; and
providing a page index on both said first column and said second column for ease of selection of an appropriate paragraph in said manuscript.
